(19) United States
(12) Patent Application Publication
(10) Pub. No.: US 2004/0112801 A1
(43) Pub. Date: Jun. 17, 2004

(54) Mineral processing device

(75) Inventors: Gulnar Ermekova, Karaganda (KZ); Burkit Mainin, Karaganda (KZ); Zhanat Mainina, Karaganda (KZ); Zhibek Mainina, Karaganda (KZ)

Correspondence Address: MACMILLAN SOBANSKI & TODD, LLC, ONE MARITIME PLAZA FOURTH FLOOR, 720 WATER STREET, TOLEDO, OH, 43604-1619, US

(73) Assignee: Burkit MAININ, Karaganda (KZ)

(21) Appl. No.: 10/677,899

(22) Filed: Oct. 2, 2003

Related U.S. Application Data
(63) Continuation of application No. PCT/KZ02/00001, filed on Jan. 21, 2002.

(30) Foreign Application Priority Data
Apr. 6, 2001 (KZ) 2001/0491.1

(51) Int. Cl. B07B 1/49

(52) U.S. Cl. 209/405; 209/409

(57) ABSTRACT

The invention concerns the field of mineral processing by gravitational method and can be used in ore and coal mining as well as other industries.

The machine has been proposed, having a unit for loading material to be processed, a unit for unloading the products processed, a drive, a unit for delivering working medium, elastic elements, a box with jigging sieve and tub with working medium connected between each other by rigid mobile elements and supports. The design of the machine provides stability and intensification of jigging process. Besides, there is a considerable decrease of energy consumption and simplicity in the design it's a pilot sample has been made, testing showed good technological results of processing and proved its high reliability and productivity.

### FIELD OF THE INVENTION

This paper is dealing with processing minerals by gravitational method and can be used in ore and coal mining as well as in some other industries.

### BACKGROUND OF THE INVENTION

There is a certain device for gravitational method of processing, “The WEMCO REMER JIG” (Machine Design <<The WEMKO REMER JIG>>WEMCO EQUIPMENT, COAL PLANTS 315C Street, St. Albans, West). It consists of an unmovable trough with sieve and a movable tub with water both are being connected by rubber diaphragm along perimeter. This tub with water is being given vertical reciprocating movement by means of special doubled eccentric mechanism. As a result vertical pulsation of under-sieve water is being achieved that is very important for jigging.

The disadvantages of the machine are the complexity of the design due to the eccentric unit construction, high inertia of the lower part of the machine, that results in high energy-consumption because of the fact that each cycle of jigging needs tub up going with the whole capacity of water as well as low efficiency of mineral processed as there is no simultaneous uprising of the whole bed characteristic of all jiggers with unmovable trough.

There is a device with gravitational processing, a prototype of a jigger for undermining where simultaneously both jigging sieve and working medium (water) pulsate (Chalenko A.—New tendencies in designing jiggers with mobile sieve: Moscow, TSNEETEItyazhmash, 1991, (Mining Equipment, series 2, No. 3, 12).

The machine consists of a unit for loading of material to be processed, a units for unloading material processed, a unit for delivering working medium, a box with a jigging sieve and a tub with the working medium, connected between each other by flexible elastic elements (flat springs) and a drive. The tub has a support shaped as a frame with the shock-absorbers. The machine is a double-mass oscillating system with elastic connection between the masses because of which the jigging sieve and working medium oscillate in counter-phase and it provides their simultaneous pulsation. Along with vertical pulsation of the under-sieve water and vertical pulsation of the jigging sieve simultaneous uprising of the whole bed is being achieved that is very important for jigging process (Bert R. Technology of gravitational processing: Translation from English/Moscow, Nedra, 1990.-219, 220).

Disadvantage for the device is instability of oscillation regime of the working unit and working medium—amplitude of oscillating jigging sieves and water—that influences negatively effectiveness of jigging process, namely decreasing the quality of products dressed as well as there are certain limits in frequency and amplitude of oscillations that decreases the possibility of the further intensification of jigging process for ores with high specific gravity. This is the consequence of the fact that the oscillations of jigging sieve and working medium are being fixed relatively to the center of gravity of a jigger.

As this machine is a double-mass one with elastic connection between masses (by means of flat spring), according to the theory of oscillation of mechanical systems (Vibration in technique. Moscow: machine building, 1978, v.4, part 2, ch.6, p.140, FIG. 5) its work will be characterized by instability of oscillating regime that results in instability of jigging process and as a consequence decreasing of the quality of products dressed. Increasing of amplitude and frequency of oscillation results in greater instability of oscillation regime.

### SUMMARY OF THE INVENTION

The technical purpose of invention is designing a simple device for gravitational processing of minerals, providing stability and intensification of the process mentioned.

This purpose is being achieved by connecting the box with the jigging sieve and the tub with the working medium connect between each other movably by means of one or more rigid elements (eg, by means of double-arm levers, etc), while at least one of the rigid mobile elements is being installed upon support movably, and elastic elements connect either two or more mobile units of the machine between each other or the support with one or more mobile units, there must being not less than one elastic element. As an example, on FIG. 1 there is a cinematic scheme of a hinged 4-link unit with rigid mobile elements in the form of double-arm levers and an elastic element in the form of coiled spring.

As we see on FIG. 1 introduction into the construction of the prototype of rigid mobile elements provides the machine with stability of the oscillation regime of operating units, as the movement of the box with the sieve and the tub with working medium has been calculated concerning rotation supports of double-arm levers. In the machine under discussion elastic elements fulfill the job of balancing power and depending on a certain combination and inertia moments of oscillating parts of the machine, necessary balance can be achieved by means of connecting two or more mobile parts by elastic elements or its mobile parts with the support.

### BRIEF DESCRIPTION OF THE DRAWINGS

FIG. 1—cinematic scheme of the machine,

FIG. 2—design of the machine, side sight.

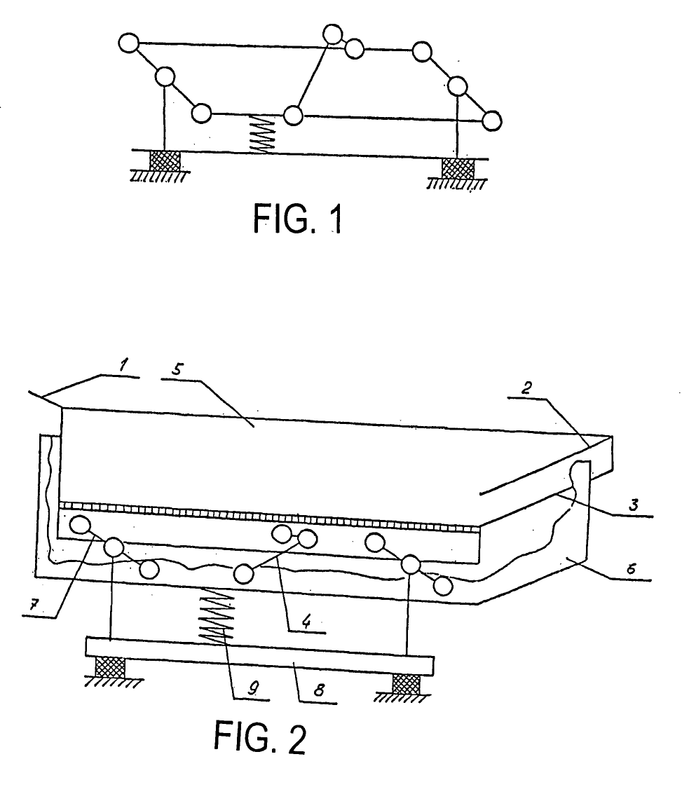

### DETAILED DESCRIPTION OF THE INVENTION

The machine under discussion (FIG. 2) has a unit for loading material to be processed, units for unloading products processed (2 and 3) (the device for unloading under sieve fines is not shown), drive 4 (as one of the variant slider-crank mechanism), box with jigging sieve and tub with working medium 6, connected between each other by rigid mobile elements 7 (as one of the variants—double-arm levers with the equal length of arm), these rigid mobile elements being fixed on the support 8, the support is connected to the tub by means of elastic elements 9 (as one of the variants coiled spring). Working medium is being transferred through unit 10 (not shown).

The designed machine operates in the following way: mineral to be processed is being transported out of loading unit 1 into the box with jigging sieve 5. Drive 4 transfers oscillating movement both to box with jigging sieve 5 and to tub with working medium 6.

Synchronically with traveling tub with working medium 6 downwards there is movements of box with jigging sieve 5 upwards that results in uprising of the whole bed. On traveling box with jigging sieve 5 downwards, tub with working medium 6 travels synchronically upwards that results in vertical pulsation of under−sieve+water. Products processed are being taken away trough unloading units 2 and 3. While unloading of products processed, the loss of working medium is being compensated by its permanent delivery trough unit 10. Stability of oscillation regime of box with jigging sieve and tub with working medium is provided by slider-crank mechanism and rigid mobile elements 7. The whole construction of the design is cinematically balanced by elastic element 9.

As a drive hydro-cylinders can be used, as well as weir revolting hydro-engines and some other devices. As working medium water, heavy-medium suspension or some other material can be used. As for elastic elements such material as springs, multiple-leaf springs, elastic diaphragm and other elements can be used, while elastic elements can bind box with tub, support with box or tub box or tub with rigid mobile element, the latter with support, etc. Installing additional devices for unloading gives possibility of getting any required quantity of products processed.

### Industrial Usage

The peculiarities of the design under discussion are very substantial, as they provide the possibility of stabilization and intensification of jigging process. Its industrial usage is out of discussion.

Cinematic scheme of the machine provides it with the requirements to treat it as oscillating system with the criterions of stability, balance and power factor.

Besides, cinematic scheme of the machine permits to increase greatly its capacity simply by enlarging its size (both in width and length) without substantial complication of the construction. At present a pilot sample has been made and its tests showed good technological results and confirmed the reliability of the device, simple in producing, using and manufacturing.

1. The machine for gravitational processing of mineral deposits consisting of box with jigging sieve and tub with working medium, drive, unit for loading material to be processed, units for unloading products processed, unit for delivering working medium, one or more elastic elements and support being different due to the fact that to achieve stability and intensification of the jigging process, box with jigging sieve and tub with working medium are being connected between each other movably by one or more rigid elements, at least one of the rigid elements is leaning on the support movably, one or more elastic elements connect either two or more mobile parts of the machine between each other or the support with one or more mobile parts of the machine.
